(19) United States
(12) Patent Application Publication
(10) Pub. No.: US 2003/0042648 A1
(43) Pub. Date: Mar. 6, 2003

(54) Method for manufacturing integrated forming shoe inserts

(76) Inventor: Mao-Cheng Tsai, Taichung (TW)

Correspondence Address: BACON & THOMAS, PLLC, 625 SLATERS LANE, FOURTH FLOOR, ALEXANDRIA, VA, 22314

(21) Appl. No.: 09/941,603

(22) Filed: Aug. 30, 2001

(51) Int. Cl. B29C 37/00; B29C 45/16

(52) U.S. Cl. 264/161; 264/257; 264/293

(57) ABSTRACT

A method for manufacturing shoe inserts includes the processes of loading, coupling, injecting, trimming and finished products to wrap and bond PU with a covering fabric (or other suitable shoe insert materials) to become an integrated product without the tedious processes of gluing, pre-cutting, bonding, folding rims or compression. The method is adaptable for mass production. The resulting finished products are sightly without exposing the composed elements or colors, and have attractive integrated

### FIELD OF THE INVENTION

The present invention relates to shoes and particularly a method for manufacturing integrated forming shoe inserts.

### BACKGROUND OF THE INVENTION

In the past, the processes of fabricating shoe inserts generally include: cutting a piece of fabric 1, a sole layer 2 and a foam layer 3 to selected dimensions in the shape of shoes with the dimension of the fabric 1 greater than that of the sole layer 2 and foam layer 3 (as shown in FIG. 1A) for wrapping the cut sole layer 2 and foam layer 3; then arranging the fabric 1, sole layer 2 and foam layer 3 in sequence and gluing the surfaces between the elements, then bonding the three elements together (as shown in FIG. 1B); finally folding the rims of the fabric downwards to wrap the sole layer 2 and foam layer 3 from outside and compress the folded rims of the fabric 1 against the sole layer 2 and foam layer 3. Hence the fabrication processes include cutting (T1), gluing (T2), bonding (T3), folding rims (T4), wrapping (T5) and compression (T6) until getting the finished product (T7) of the shoe inserts (referring to FIG. 2).

The conventional processes set forth above are very tedious. The fume generated by the adhesive used in the gluing process is toxic and harmful to human body. As a result workers are difficult to recruit and labor costs are very high. To remedy these problems, some improvements on fabrication processes have been made. FIG. 3 illustrates one of the improved fabrication methods for making shoe inserts that include the steps of loading S1, molding S2, injecting S3, trimming S4 and finished products S5. More details will be elaborated below.

Referring to FIG. 4A, the method mentioned above include: loading a fabric 4 on an upper mold of a mold set S2; then coupling the upper mold and the lower mold and injecting PU foaming materials S3 into the mold set S2; after the PU foaming materials expand and form a desired shape, the fabric 4 and a PU 5 will be bonded together to form an integral product (as shown in FIG. 4B), then trimming S4 the extra fabric 4 from the integral product to become a finished product S5.

While the method set forth above may save the process steps of gluing (T2), bonding (T3), folding rims (T4) and wrapping (T5), and prevent generating the toxic fume, and makes recruiting workers easier and can reduce some labor costs, the fabric 4 does not wrap the PU 5 in the finished products. Hence the composed elements of the insert are exposed on the lateral side of the insert with different colors. It is not sightly and decreases the value of the products.

Moreover, the foregoing method is not adaptable for mass production. All this indicates that there are still rooms for improvements.

### SUMMARY OF THE INVENTION

The primary object of the invention is to provide a method for manufacturing shoe inserts that integrates PU and fabric layer together to reduce secondary fabricating time and costs and to facilitate mass production.

To attain the foregoing object, the method of the invention includes the processes of: loading, coupling, injecting, trimming and finished products. Through the processes, the covering fabric (or other suitable shoe insert materials) and PU are bonded and wrapped together to become an integral member without the needs for the processes of gluing, pre-cutting, folding rims and compressing. The processes of the invention are adaptable for mass production. The finished products are sightly and have more appealing without exposing the composed elements or colors, and may result in greater product value.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is a schematic view of an earlier shoe insert structure, unfinished.

FIG. 1B is a schematic view of an earlier shoe insert structure according to FIG. 1A, finished.

FIG. 2 is an earlier fabrication process flow for making shoe inserts.

FIG. 3 is a conventional fabrication process flow for making shoe inserts.

FIG. 4A is a schematic view of a conventional mold and fabric for making shoe inserts.

FIG. 4B is a schematic view of a finished shoe insert according to FIG. 4A.

FIG. 5A is a schematic view of a mold set and fabric for making shoe inserts according to the invention.

FIG. 5B is a schematic view of a process step according to FIG. 5A.

FIG. 5C is a schematic view of another process step according to FIG. 5A.

FIG. 5D is a fragmentary enlarged view of FIG. 5B.

FIG. 6A is a schematic perspective view of a n upper mold of the invention.

FIG. 6B is a schematic perspective view of an embodiment of a ramming strut of the invention.

FIG. 6C is a schematic perspective view of another embodiment of a ramming strut of the invention.

FIG. 7 is a manufacturing process flow of the invention.

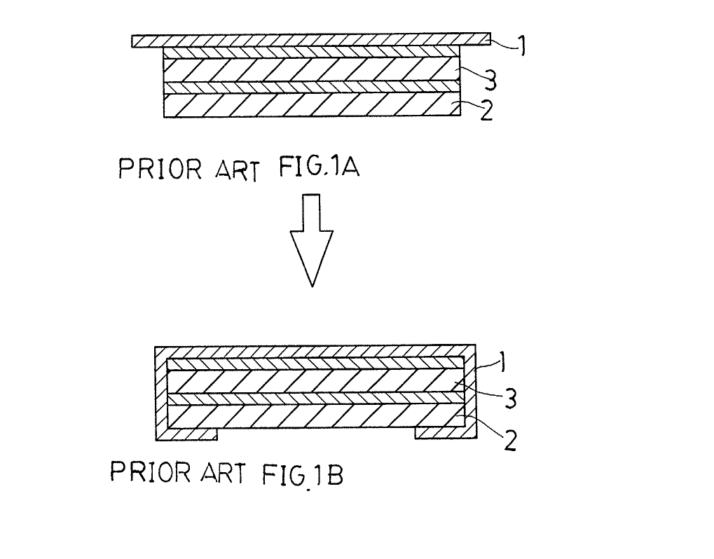

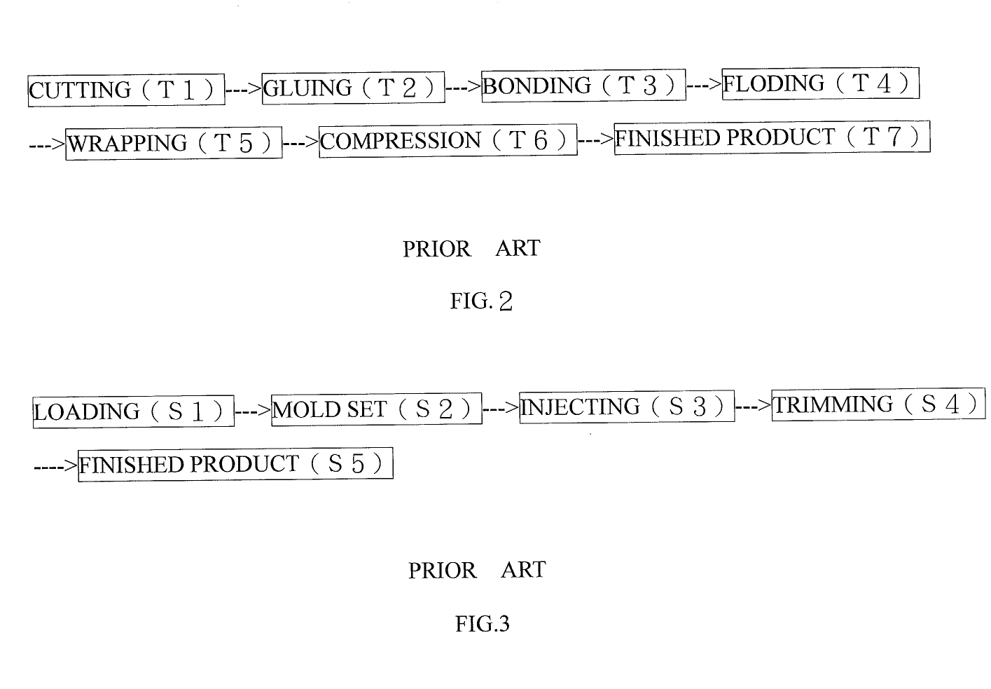

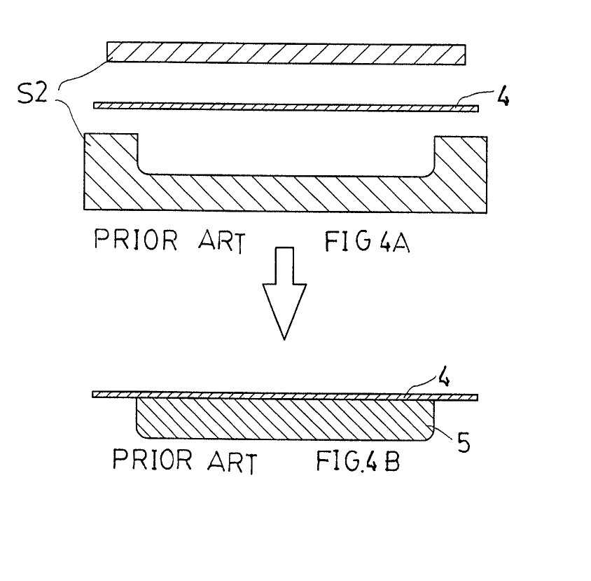

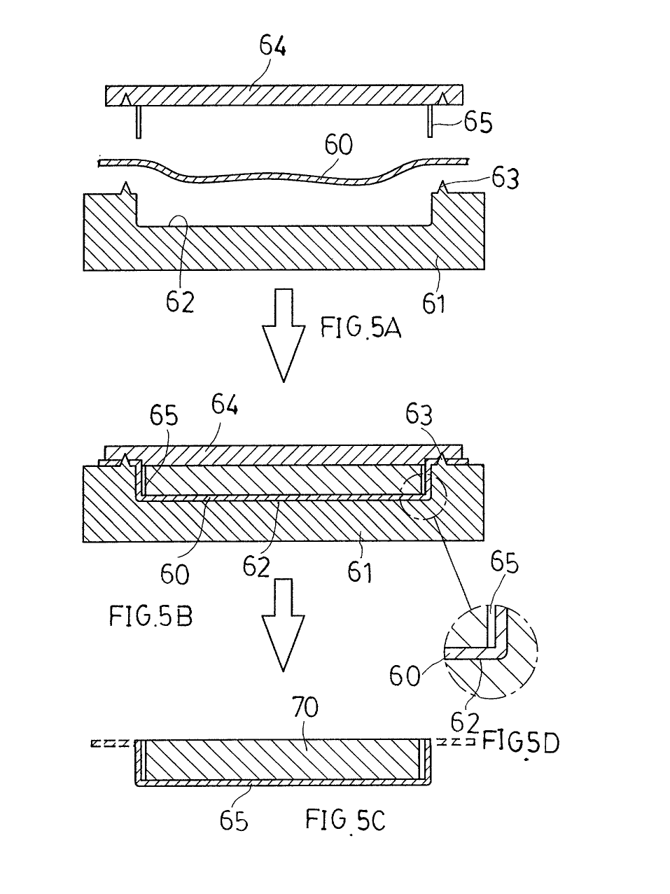

### DESCRIPTION OF THE PREFERRED EMBODIMENT

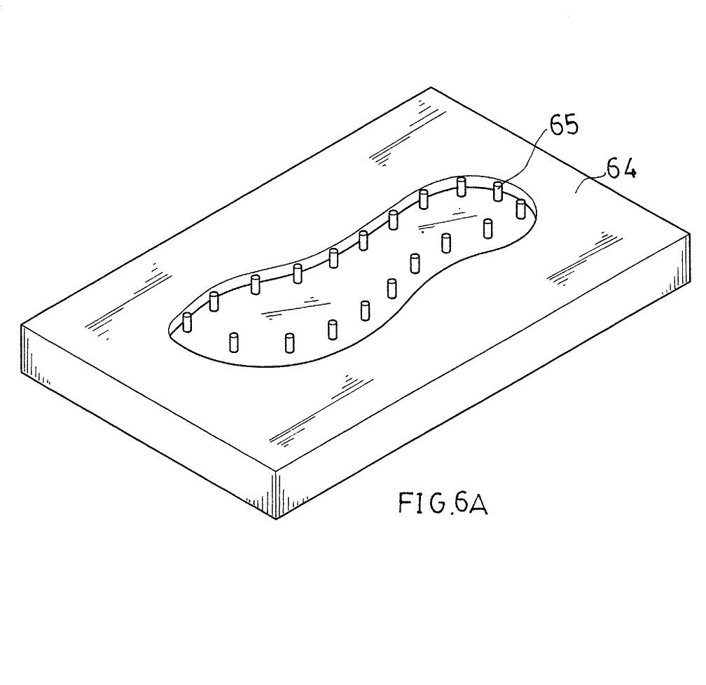

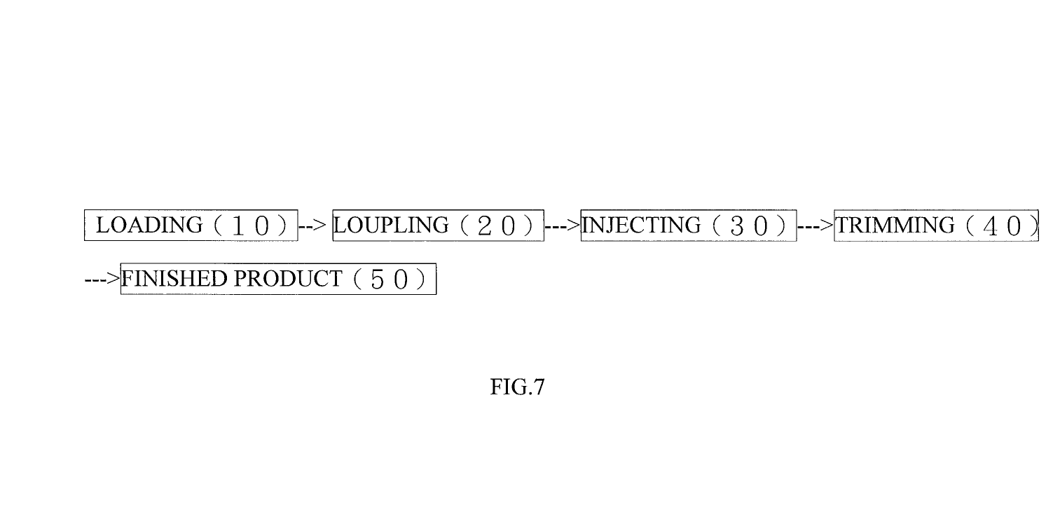

Referring to FIGS. 5A through 7 for the method of the invention, the processes of the invention mainly includes the steps of: loading 10, coupling 20, injecting 30, trimming 40 and finished products 50.

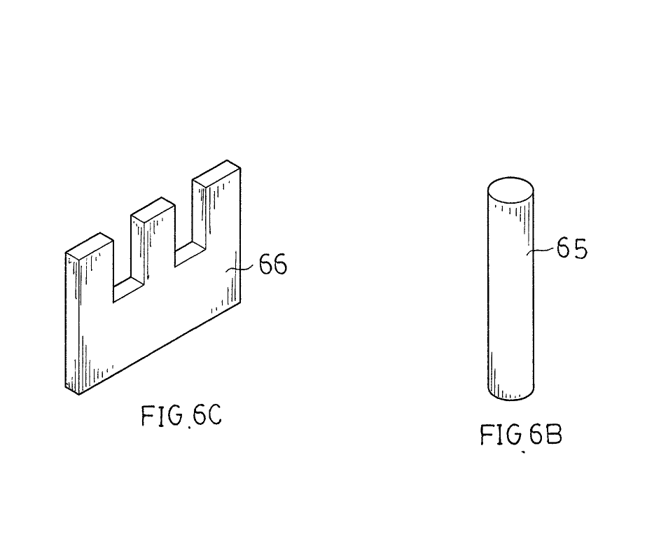

The step of loading 10 is to place a covering fabric 60 on a lower mold 61 over a mold cavity 62 formed in the lower mold 61 in the shape of a shoe insert. The outer rim of the mold cavity 62 has a plurality of anchor spikes 63 formed thereon for anchoring the covering fabric 60. There is an upper mold 64 which has a lower surface with a plurality of ramming struts 65 formed thereon mating the mold cavity 62 of the lower mold 61 (as shown in FIG. 6A). The ramming strut 65 may be in the form of a round rod (as shown in FIG. 6B) or a ramming ledge with jutting teeth formed on the top end in an intermittent fashion (as shown in FIG. 6C).

The step of coupling 20 is to engage the upper mold 64 with the lower mold 61. After coupling, the ramming struts 65 of the upper mold 64 will ram and stretch the covering fabric 60 tightly into the lower mold 61 (as shown in FIG. 5B and 5D) against the inner walls of the mold cavity 62.

The step of injecting 30 is to inject PU material into the mold set on the covering fabric 60. When the PU material foams and expands, the PU will be bonded to the covering fabric 60 and become integrated.

The step of trimming 40 is to cut off and remove extra covering fabric 60 extending outside the PU 70 to form a finished product of the shoe insert.

By means of the invention, the covering fabric 60 may be processed through the processes of loading 10, coupling 20, injecting 30, trimming 40 and finished products 50 to bond integrally and easily with the PU 70, and wrap the PU in the interior. The method of the invention offers the following advantages:

1. The ramming struts 65 of the upper mold 64 can stretch the original loose covering fabric 60 (as shown in FIG. 5A) tightly into the lower mold 61 and anchor the covering fabric 60 against the mold cavity 62 without gaps. When the PU material is foamed and expanded, the resulting PU 70 will be formed exactly same as the mold cavity 62 of the lower mold 61 without defect such as producing breaches.

2. The invention does not need gluing, thus does not generate toxic fume from the gluing adhesives that might other incur. As the processes are safer, it is easier to recruit workers and can reduce labor costs.

3. The invention adopts an integrated injection forming process and does not have the tedious and time-consuming processes of pre-cutting elements in the form of shoe inserts and repeatedly gluing which prohibit mass production. This invention can be adapted for mass production easily.

4. The finished products of the invention have the PU completely wrapped and covered without exposing the composed elements or colors, thus the overall appearance of the finished products are more sightly and attractive, and can increase the product value.

What is claimed is:

1. A method for manufacturing integrated shoe inserts, comprising the steps of:
loading, a covering fabric in a mold set;
coupling, the mold set;
injecting, PU into the mold set to bond the covering fabric for forming an integral PU product; and
trimming, extra covering fabric from the PU product to form finished products.

2. The method of claim 1, wherein the mold set has anchor spikes for anchoring the covering fabric.

3. The method of claim 1, wherein the mold set has ramming struts for stretching the covering fabric.

4. The method of claim 3, wherein each of the ramming struts is a round rod.

5. The method of claim 3, wherein each of the ramming struts is a ramming ledge with jutting teeth formed on the top end thereof in an intermittent fashion.
